(19) United States
(12) Patent Application Publication
(10) Pub. No.: US 2024/0383433 A1
(43) Pub. Date: Nov. 21, 2024

(54) THIN-WALLED EXPANDED METAL FILTERS

(71) Applicant: ACS Industries, Inc., Lincoln, RI (US)

(72) Inventor: Steven D. Huntsman, North Ogden, UT (US)

(73) Assignee: ACS Industries, Inc., Lincoln, RI (US)

(21) Appl. No.: 18/665,613

(22) Filed: May 16, 2024

Related U.S. Application Data
(60) Provisional application No. 63/503,186, filed on May 19, 2023.

(51) Int. Cl. B60R 21/26; B01D 39/12; B01D 46/40

(52) U.S. Cl. CPC B60R 21/26; B01D 39/12; B01D 46/403; B60R 2021/26011

(57) ABSTRACT

Filters (21) comprising a rolled expanded metal strip (13) are provided. The expanded metal strip (13) has an entrance zone (e.g., layer 1 and layer 2), a nozzle zone (e.g., layer 3), and, optionally, an exit zone (e.g., layers 4 and 5). The filter can also include an optional layer of woven wire mesh (e.g., layer 6). The filters have a thin wall (39) such that, in an embodiment, the ratio of the thickness (t) of the wall to the filter's outer diameter (OD) is less than or equal to 0.07, whereby the filter can weigh less and/or have a smaller envelope size than existing expanded metal filters. In an embodiment, the filter (21) can be used to filter and cool the gas stream produced by the rapid burning of the solid propellant (26) of an airbag inflator (157).

### CROSS-REFERENCE TO RELATED APPLICATIONS

This application claims the benefit of U.S. Provisional Patent Application No. 63/503,186, filed May 19, 2023, the entire contents of which are incorporated herein by reference.

### FIELD

This disclosure relates to filters made, at least in part, from expanded metal. In certain embodiments, the filters are used in airbag inflators.

### BACKGROUND

### A. Expanded Metal

Expanded metal has found a variety of uses, from mats used for fighting fires to filters for airbag inflators. Expanded metal can be made in a variety of ways. For example, expanded metal can be made by taking a sheet of metal, puncturing the sheet to produce a multiplicity of slits, and pulling the sheet perpendicular to the direction of the slit to elongate the slit and provide an opening (aperture) in the sheet. Another common method for making expanded metal is by piercing and cold forming openings, which are often called “diamonds” because of their final shape. The final length of the sheet, with the accompanying apertures, is longer than the original and so it is expanded, as well as the apertures formed being expanded.

Thus, although the details will vary depending on the specific process, expanded metal sheets are typically made by using a row of teeth or bits in a punch to produce perforations in the sheet. The side of the sheet facing the punch will have an indentation around the perforation, and the reverse side of the sheet will have a corresponding raised portion, a burr, around the perforation. In certain embodiments, the expanded metal sheet is passed through rollers to flatten the burrs.

### B. Filters for Airbag Inflators

Filters for airbag inflators need to satisfy a number of demanding criteria. Such filters serve to capture the extensive debris (slag) that is generated during the rapid burning of an airbag's solid propellant. The slag can damage the airbag and if released from the airbag can injure occupants of the vehicle in which the airbag deployed. In addition, the slag is often harmful to humans. To address these concerns, manufacturers of airbag inflators have developed strict standards for the amount of slag that can be emitted from an airbag inflator upon activation. The customary standard in the U.S. for airbag assemblies of all types is a maximum of 1,000 milligrams of total particulates (total slag) reaching the airbag cushion as a result of a deployment of an airbag assembly.

For an airbag inflator to meet this customary standard, its filter needs to be highly effective in its filtering function. Yet, it must also allow the gas generated by the burning of the solid propellant to quickly reach and inflate the airbag. That is, the filter cannot generate excessive levels of backpressure. Moreover, the filter needs to satisfy these conflicting criteria, i.e., effective filtering with low backpressure, in the midst of the high forces produced by the rapid burning of the solid propellant. Besides these criteria, the filter also serves as a pre-diffuser to the inflator to help attain a more even flow of the expanding gases entering the airbag and as a heat sink acting as a thermodynamic diffuser to help reduce the temperature of the gases so that they will not harm the airbag cushion or the person being protected by the airbag cushion.

The expanded metal filters sold by the assignee of this application under the VEM trademark and produced in accordance with the technology of commonly-assigned Greenwood U.S. Pat. No. 10,717,032 achieve the above performance criteria and have enjoyed extensive commercial success through their widespread adoption by manufacturers of airbag inflator assemblies. Notwithstanding this success, there has been a long-standing demand for filters that achieve the performance criteria but weigh less or have a smaller envelope size or both weigh less and have a smaller envelope size than the existing VEM filters.

The challenge has been to reduce the filter's weight and/or size without compromising its performance. As discussed in detail below, it has been found that the filter's weight and/or size can be reduced through the use of the expanded metal aperture patterns discussed below and set forth in the claims. Surprisingly, these patterns allow the thickness of the filter's wall to be significantly reduced which, in turn, allows the filter's weight and/or its envelope size to be reduced, all without compromising the filter's performance when an airbag inflator is deployed. Furthermore, these improvements can be achieved while controlling the filter's cost which is always an issue for a mass-produced item, especially one used in the automotive field.

Although low weight and/or small size and/or thin wall thickness are particularly valuable in connection with filters for airbag inflators, these properties of the expanded metal filters disclosed herein are of value generally in connection with filters composed entirely or in part of expanded metal.

### SUMMARY OF THE DISCLOSURE

In accordance with a first aspect of the disclosure, a filter is provided that comprises a strip of expanded metal rolled-up about an axis to form multiple layers, said strip of expanded metal having a longitudinal axis and a transverse axis and comprising a plurality of apertures arranged in rows oriented perpendicular to the longitudinal axis, the strip being rolled up along the longitudinal axis to form the filter, wherein:
(I) the rolled-up filter has an inner surface having a diameter ID, an outer surface having a diameter OD, and a wall thickness t=½(OD−ID);
(II) each of the filter's layers:
   (a) comprises a plurality of rows of apertures; and
   (b) is characterized by:
      (i) a spacing between rows of apertures referred to as S_{longitudinal} and expressed as apertures/cm,
      (ii) a spacing between apertures within rows referred to as Sₜᵣₐₙₛᵥₑᵣₛₑ and expressed as apertures/cm,
      (iii) an open area for each of the layer's apertures referred to as OAₐₚₑᵣₜᵤᵣₑ and expressed as cm²/aperture,
      (iv) a total open area for the layer referred to as TOA_{layer} and given in percent by:

TOA_{layer}=100*S_{longitudinal}*Sₜᵣₐₙₛᵥₑᵣₛₑ*OAₐₚₑᵣₜᵤᵣₑ, and
(v) an aperture density for the layer referred to as D_{layer} and expressed as apertures/cm²;
(III) the strip of expanded metal comprises an entrance zone which forms at least two layers in the rolled-up filter and a nozzle zone which forms a single layer in the rolled-up filter, the entrance zone being closer to the inner surface of the rolled-up filter than the nozzle zone;
(IV) the TOA_{layer} of the single layer of the nozzle zone is smaller than the TOA_{layer}'s of all of the layers of the entrance zone;
(V) for each layer of the entrance and nozzle zones, Sₜᵣₐₙₛᵥₑᵣₛₑ is greater than or equal to 4 apertures/cm (or in the range from greater than or equal to 4 apertures/cm to less than or equal to 10 apertures/cm, or in the range from greater than or equal to 4 apertures/cm to less than or equal to 6 apertures/cm);
(VI) at least one layer of the entrance zone has a D_{layer} greater than or equal to 64 apertures/cm² (or greater than or equal to 67 apertures/cm², or greater than or equal to 69 apertures/cm²); and

$$t / OD \leq 0.07 ( or t / OD \leq 0.072 , or t / OD \leq 0.074 ) \qquad ( VII )$$

In certain embodiments, the filter of the first aspect of the disclosure has one, more than one, or all of the following features:
(1) the thickness of the strip of expanded metal is less than or equal to 0.54 millimeters (or less than or equal to 0.57 millimeters, or less than or equal to 0.060 millimeters);
(2) each of the layers of the entrance zone has a D_{layer} greater than or equal to 64 apertures/cm² (or greater than or equal to 67 apertures/cm², or greater than or equal to 69 apertures/cm²);
(3) the TOA_{layer} of the single layer of the nozzle zone is in the range of greater than or equal to 4% to less than or equal to 20% (or greater than or equal to 4% to less than or equal to 15%, or greater than or equal to 4% to less than or equal to 10
(4) the strip of expanded metal further comprises an exit zone which forms at least two layers in the rolled-up filter, the exit zone being farther from the inner surface of the rolled-up filter than the nozzle zone, wherein:
   (a) for each layer of the exit zone, Sₜᵣₐₙₛᵥₑᵣₛₑ is greater than or equal to 4 apertures/cm (or in the range from greater than or equal to 4 apertures/cm to less than or equal to 10 apertures/cm, or in the range from greater than or equal to 4 apertures/cm to less than or equal to 6 apertures/cm);
   (b) the TOA_{layer} of the single layer of the nozzle zone is smaller than the TOA_{layer}'s of all of the layers of the exit zone;
(5) the strip of expanded metal consists of the entrance zone, the nozzle zone, and the exit zone;
(6) the rows of apertures are staggered so that aperture open areas for adjacent layers are at different circumferential angles, where a circumferential angle is the angle of the center of the aperture as seen from the axis about which the filter has been rolled;
(7) the entrance zone has an innermost layer that forms the filter's inner surface;
(8) the filter further comprises a layer of woven metal mesh which forms the filter's outer surface;
(9) the filter does not comprise ceramic paper; and/or
(10) the filter is used exclusively for an airbag inflator filter.

In accordance with a second aspect of the disclosure, an apparatus for helping to protect an occupant of a vehicle is provided that comprises:
(I) an inflatable vehicle occupant protection device; and
(II) an inflator that is actuatable to provide inflation fluid for inflating the inflatable vehicle occupant protection device;
wherein the inflator comprises:
   (A) a solid propellant; and
   (B) a filter according to the first aspect of the disclosure.

In certain embodiments, the apparatus of the second aspect of the disclosure has one, more than one, or all of the following features:
(1) the cooling efficiency of the apparatus' filter is at least 6° C./gram of filter for a drop in the temperature of the inflation fluid from about 1700° K (in the filter's cavity) to about 850° K (at the exit from the filter's housing);
(2) the mass of the apparatus' filter is less than or equal to 160 grams (or less than 165 grams, or less than 170 grams);
(3) the solid propellant is located within the filter's inner surface, the inflator comprises a housing for the filter, and the filter and the housing are manually separatable into individual components after rapid burning of the solid propellant.

In accordance with a third aspect of the disclosure, a method of filtering and cooling a fluid is provided that comprises passing the fluid through a filter according to the first aspect of the disclosure wherein:
(I) the fluid comprises a gaseous component and liquid, solid, and liquid/solid particles whose size distribution includes particles capable of increasing the filter's backpressure as a result of clogging of apertures of the nozzle zone;
(II) the filter's entrance zone cools the fluid and filters out particles including a substantial amount of the particles capable of increasing the filter's backpressure; and
(III) the filter's nozzle zone filters out particles and increases the velocity of the fluid.

In certain embodiments of the third aspect of the disclosure, the fluid is inflation fluid for inflating an inflatable vehicle occupant protection device.

In accordance with a fourth aspect of the disclosure, a method of filtering and cooling a fluid is provided that comprises passing the fluid through a filter according to the first aspect of the disclosure wherein:
(I) in addition to its entrance zone and nozzle zone, the filter's strip of expanded metal comprises an exit zone which forms at least two layers in the rolled-up filter, the exit zone being farther from the inner surface of the rolled-up filter than the nozzle zone;
(II) the fluid comprises a gaseous component and liquid, solid, and liquid/solid particles whose size distribution includes particles capable of increasing the filter's backpressure as a result of clogging of apertures of the nozzle zone;
(III) the filter's entrance zone cools the fluid and filters out particles including a substantial amount of the particles capable of increasing the filter's backpressure;
(IV) the filter's nozzle zone filters out particles and increases the velocity of the fluid; and
(IV) the filter's exit zone filters out particles and cools the fluid through expansion.

In certain embodiments of the fourth aspect of the disclosure, the fluid is inflation fluid for inflating an inflatable vehicle occupant protection device.

Additional properties and advantages of the technology disclosed herein are set forth in the detailed description that follows, and in part will be readily apparent to those skilled in the art from that description or recognized by practicing the technology as described herein. The accompanying drawings are included to provide a further understanding of the technology and are incorporated in and constitute a part of this specification. It is to be understood that the various aspects and features of the technology disclosed in this specification and in the drawings can be used individually and in any and all combinations. It is also to be understood that the general description set forth above and the detailed description which follows are merely exemplary of the invention and are intended to provide an overview or framework for understanding the nature and character of the invention as defined by the claims.

### BRIEF DESCRIPTION OF THE DRAWING FIGURES

FIG. 1 is a schematic depiction of an airbag filter according to an embodiment of the disclosure in which the filter is in the form of a tube having an inner surface which defines a central bore or cavity, an outer surface, and substantially flat end sections which extend between the inner surface and the outer surface. Pellets of a pyrotechnic composition are located within the bore of the filter. The filter includes an outer layer of woven wire mesh or expanded metal in this embodiment.

FIG. 2 is a schematic depiction of an airbag filter according to an embodiment of the disclosure in which, as in FIG. 1, the filter is in the form of a tube having an inner surface which defines a central bore or cavity, an outer surface, and substantially flat end sections which extend between the inner surface and the outer surface. Pellets of a pyrotechnic composition are again located within the bore of the filter. In this case, the filter does not include an outer layer of woven wire mesh, but instead the outer layer is expanded metal.

FIG. 3 is a schematic depiction of a strip for forming the filter of FIG. 1 or FIG. 2, the strip including layers of expanded metal when the FIG. 1 filter is to be formed and an additional layer of woven wire mesh when the FIG. 2 filter is to be formed.

FIG. 4 is a schematic depiction of the longitudinal and transverse axes of the strip of FIG. 3.

FIG. 5 is a schematic depiction of the strip of FIG. 3 after being rolled up to form a filter.

FIG. 6 is a schematic depiction of the strip of FIG. 3 after being rolled up illustrating the inner diameter (ID), outer diameter (OD), and wall thickness (t) of the filter.

FIG. 7 is a schematic depiction of an embodiment of equipment for making expanded metal.

FIG. 8 is a schematic depiction of an airbag assembly.

FIG. 9 is a photograph of an airbag inflator housing with which the filters disclosed herein can be used.

FIG. 10 is a schematic depiction of the filter of FIG. 1 after rapid burning of an inflator's solid propellant.

FIG. 11 illustrates an exemplary camera configuration for strip/hole open area image acquisition;

FIG. 12 is an exemplary strip image acquired with the camera configuration as illustrated in FIG. 11;

FIGS. 13-17 illustrate open area hole and percentage results presented in Table and Graph formats for the exemplary strip in FIGS. 20A-20G;

FIGS. 18A-18G illustrate an exemplary Prior Art strip and representative open area data points showing entrance and nozzle zones which do not have a steep decreasing value;

FIGS. 19A-19G illustrate another exemplary Prior Art strip and representative open area data points showing entrance and nozzle zones which do not have a steep decreasing value;

FIGS. 20A-20G illustrate an exemplary strip and representative open area data points showing entrance and nozzle zones which have a steep decreasing value in accordance with the teachings of the present invention;

FIGS. 21A-21G illustrate another exemplary strip and representative open area data points showing entrance and nozzle zones which have a steep decreasing value in accordance with the teachings of the present invention; and

FIGS. 22A-22G illustrate an exemplary strip and representative open area data points showing entrance and nozzle zones which have a steep decreasing value in accordance with the teachings of the present invention.

The reference numbers used in the figures correspond to the following:
11 metal strip prior to rolling
13 expanded metal strip
14 woven metal mesh
15 filter housing
17 aperture of filter housing
19 upper portion of filter housing
20 thin gap between used filter and filter housing
21 substantially cylindrical filter
22 substantially cylindrical inner surface of filter 21
23 cavity of filter 21 defined by inner surface 22
24 substantially cylindrical outer surface of filter 21
25 substantially flat end sections of filter 21
26 solid propellant
27 residue captured by filter 21 after burning of solid propellant
31 apertures in the expanded metal strip
33 longitudinal axis of strip 11
35 transverse axis of strip 11
37 axis of rolled-up filter
39 filter wall
101 roll of metal sheet
103 press
105 punch
107 teeth or bits
109 stretcher
111 camera
113 computer controller
115 monitor
121 rollers
123 cutter
125 expanded metal piece
155 airbag assembly
157 airbag inflator
159 inflatable vehicle occupant protection device

### DETAILED DESCRIPTION OF THE EXEMPLARY EMBODIMENTS

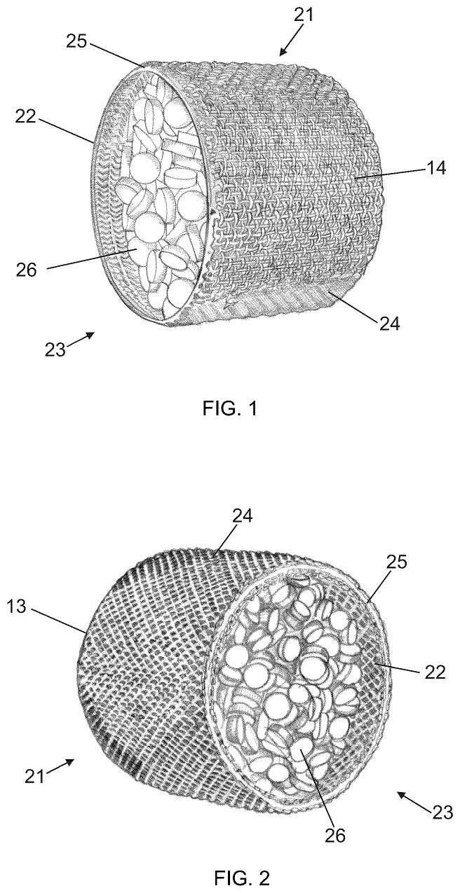

FIGS. 1 and 2 are schematic depictions of embodiments of expanded metal filters 21 suitable for use in airbag inflator assemblies. In each embodiment, the filter has an inner surface 22 which defines a central bore or cavity 23, an outer surface 24, and substantially flat end sections 25 which extend between the inner surface 22 and the outer surface 24. The outer surfaces of the two embodiments differ in that woven metal mesh 14, which has been welded to the filter's expanded metal strip, forms the outer surface in the FIG. 1 embodiment, while the expanded metal strip 13 itself forms the outer surface in the FIG. 2 embodiment. The use of woven metal mesh increases the hoop strength of the filter and is advantageous in embodiments where, for example, reduced expansion of the filter upon deployment of an airbag inflator is desired.

In the assembled inflator, the bore of the filter typically houses some and, in many cases, all the inflator's solid propellant 26. The solid propellant is typically in the form of compressed pellets of a pyrotechnic composition. During a deployment of an airbag inflator, the gas that fills up the airbag is generated by the solid propellant, which is, most commonly, based on guanidine nitrate. The propellant is normally highly loaded with copper and other metals, which in some cases can constitute 60% or more of the overall composition. During an airbag inflator deployment, the metals in the propellant liquefy and become entrained in the gas produced by the burning of the propellant. In this very dynamic system, this phase change from a solid to a liquid happens in a few dozen milliseconds.

The inflator filter's job is to thermodynamically diffuse and cool the hot burning gas such that the liquid copper and other metals are transformed back into the solid phase so that they can be captured in the filter, with only the cooled gas escaping. Car companies are very concerned with the amount of slag coming out of the inflator. If an inflator puts out more than 1 total gram of residues and/or airborne particulates (collectively, slag) then the inflator will be rejected by car companies for not meeting the USCAR standards established by NHTSA and other safety automotive groups to protect asthmatic occupants and others susceptible to health problems from exposure to airborne particulates. Filters produced using the technology disclosed herein are able to satisfy the USCAR standards notwithstanding their thin walls.

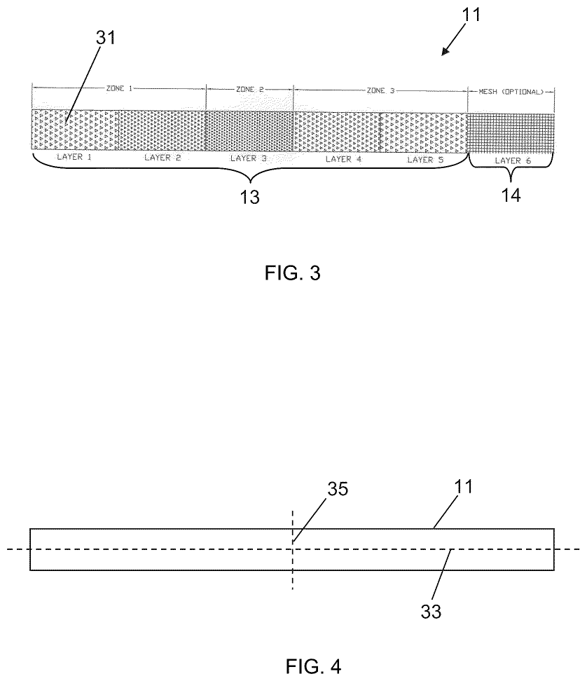

FIGS. 3 and 4 are schematic depictions of metal strips 11 prior to being rolled to form the filters of FIGS. 1 and 2. In FIG. 3, strip 11 comprises a strip 13 of expanded metal to which has been welded a piece of woven metal mesh 14, the use of which is optional. As schematically shown in FIG. 4, strip 11 has a longitudinal axis 33 and a transverse axis 35.

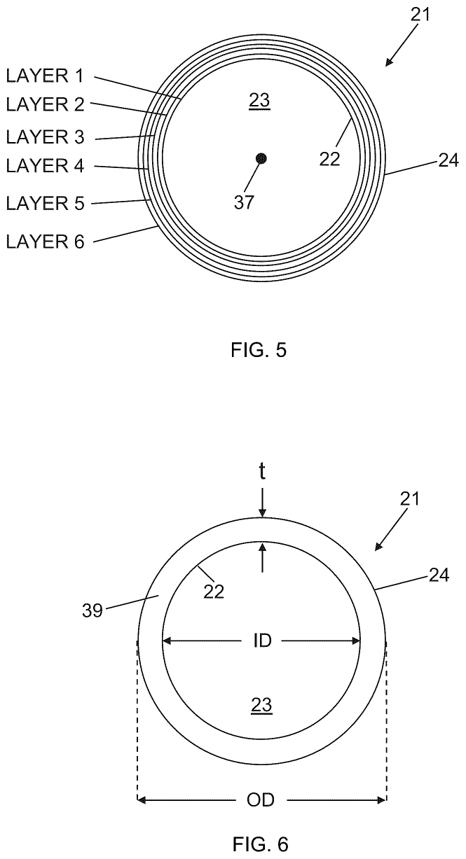

FIG. 5 is a schematic, transverse, cross-section of a filter formed by rolling up the strip of FIG. 3 along the strip's longitudinal axis 33. The axis about which the strip has been rolled is identified by the reference number 37 in FIG. 5. The spacing between layers has been exaggerated in FIG. 5 for purposes of illustration, the layers of the filter being in contact in an actual filter, e.g., through contact of burrs on the outer surface of one layer with the inner surface of the next outboard layer. FIG. 6 is a schematic, transverse, cross-section of a filter showing the filter's outer diameter OD, its inner diameter ID, and its wall thickness t (t=½(OD−ID)).

As shown in FIG. 3, strip 11 has a plurality of regions which, as shown in FIG. 5, become LAYER 1 through LAYER 6 in the rolled-up filter. In this embodiment, LAYER 1 through LAYER 5 are expanded metal layers and optional LAYER 6 is a woven metal mesh layer.

Although expanded metal strip 13 is shown with five regions in FIG. 3, it is to be understood that this number is only for purposes of illustration and the expanded metal strip can have more regions or less regions, with the minimum number of regions being three (see below). Also, although only a single region of woven metal mesh is shown in FIG. 3, additional woven mesh regions forming additional layers in the rolled-up filter can be used, with the regions having the same or different properties. A single region of woven metal mesh forming a single layer in the rolled-up filter is preferred. For purposes of illustration, in FIG. 3, the expanded metal strip 13 is shown as having the same set of regions irrespective of whether the optional woven metal mesh is used, it being understood that, in practice, expanded metal strips employed in the two embodiments can differ in terms of the number of regions used and/or the aperture patterns of the regions.

Based on extensive experimental studies, it has been found that the following parameters of the layers of the rolled-up filter are effective, indeed, critical, in achieving one or more, and preferably all, of thin wall thickness, low weight, and small size for a filter: (1) open area OAₐₚₑᵣₜᵤᵣₑ of apertures 31 expressed as cm²/aperture; (2) spacing between rows of apertures S_{longitudinal} expressed as apertures/cm; (3) spacing between apertures within rows Sₜᵣₐₙₛᵥₑᵣₛₑ expressed as apertures/cm; (4) aperture density D_{layer} expressed as apertures/cm²; and (5) total open area TOA_{layer} given in percent by:

$${TOA}_{layer} = 100 * {S}_{longitudinal} * {S}_{transverse} * {OA}_{aperture} .$$

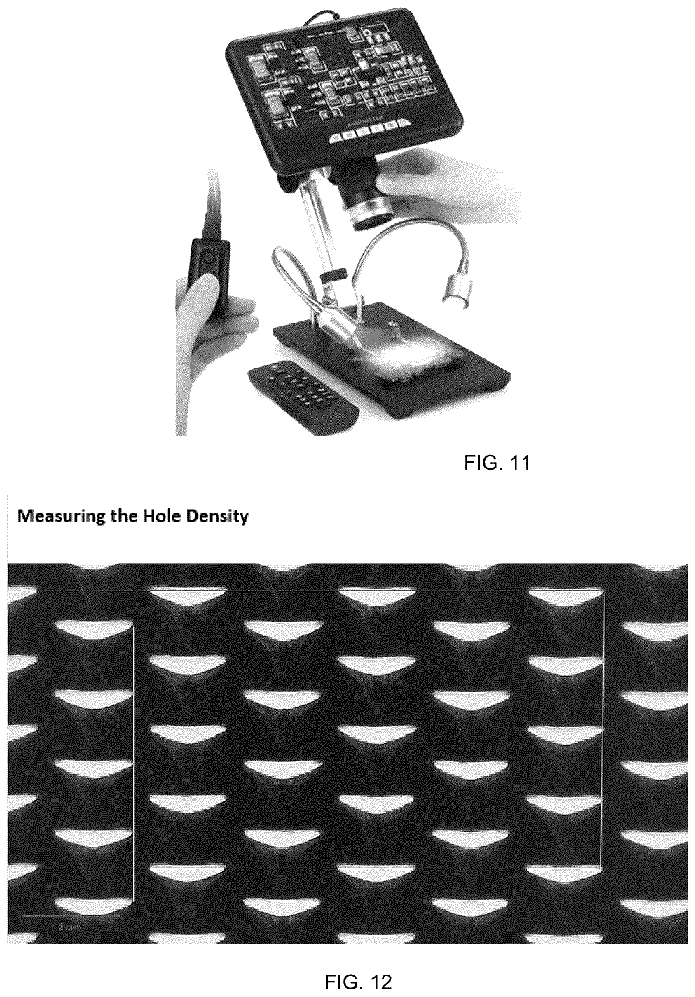

Since each layer of the rolled-up filter corresponds to a region of expanded metal strip 13, these parameters also apply to the strip. The parameters S_{longitudinal} and Sₜᵣₐₙₛᵥₑᵣₛₑ are in the directions of longitudinal axis 33 and transverse axis 35 in FIG. 4, respectively. In practice, the values for the above parameters are average values for a layer obtained by measuring the parameters for the corresponding region of the strip from which the filter is made. The measurement is performed optically by passing light through the strip's apertures and analyzing the transmitted light using a camera similar to one made by Teledyne or AndonStar with a suitable analysis; while the camera is positioned at 60 degree up from a flat plane, and a distance of 6″ from the light source (see FIGS. 11-12). The camera thus counts the number of pixels of light coming through the individual apertures, where each 0.01 pixel is equal to 0.00265458 mm A simple algorithm being used to thus convert the number of light pixels to OAₐₚₑᵣₜᵤᵣₑ.

A more detailed explanation of the methodology follows:
Microscope
Andonstar Digital Microscope AD207
8× to 20× magnification. 12× typically used on this project.
Modified to enable transmission mode.
Captured Image Properties
Size: 5.93 MB
Width=1920 pixels
Height=1080 pixels
Resolution=300 ppi
Width=6.4″
Height=3.6″
Image Analysis Software: Image J
Set Scale using stage micrometer
Import image
Remove low intensity pixels (Brightness/Contrast)
Threshold set to Image J default
Use Wand Tool to Select 15-20 contiguous holes. 5×4 matrix is one option.
Create a mask to eliminate other holes and noise.
Use Analyze Particle function to automatically collect hole data. [Area, Size, Perimeter]
Calculate average values.
Excel Spreadsheet
Current model combines line-count (holes/inch) data with Image J area data

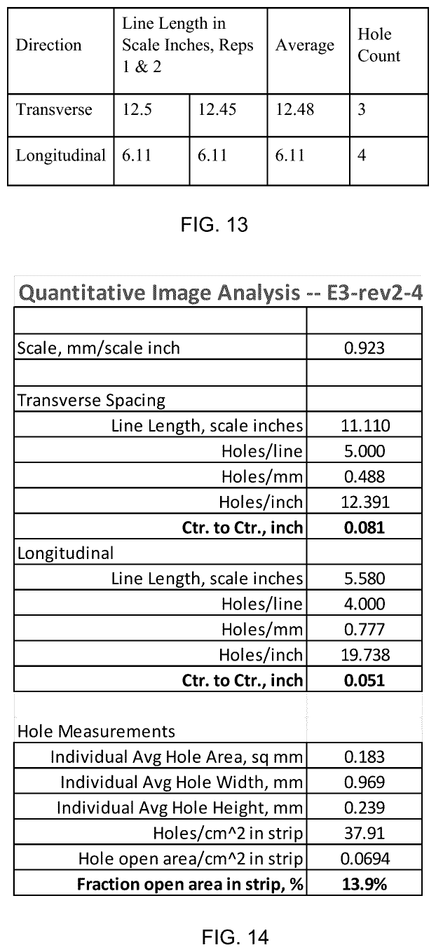

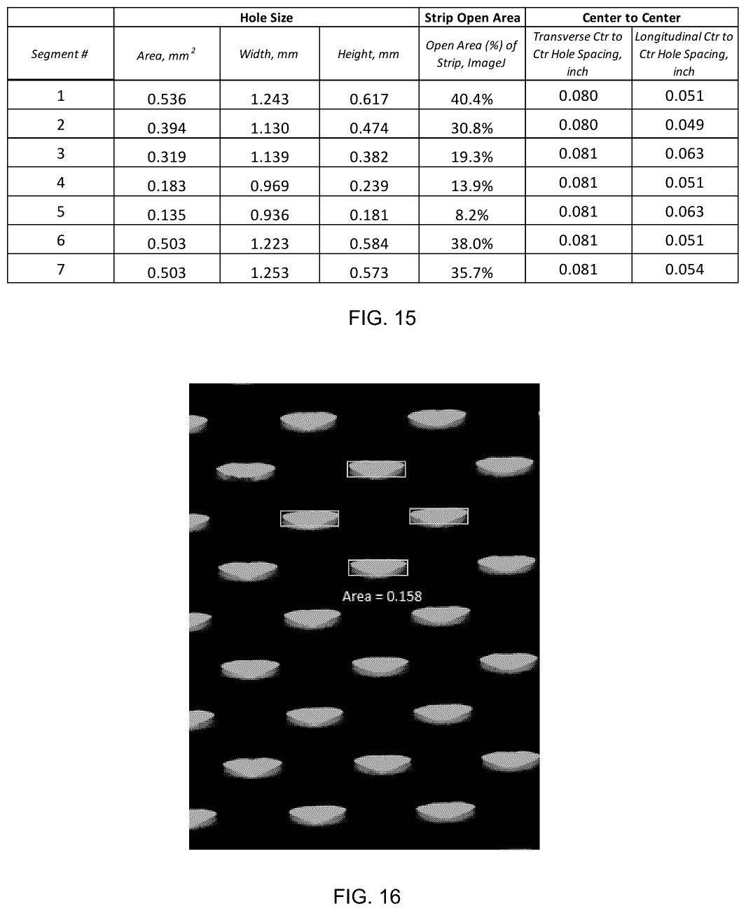

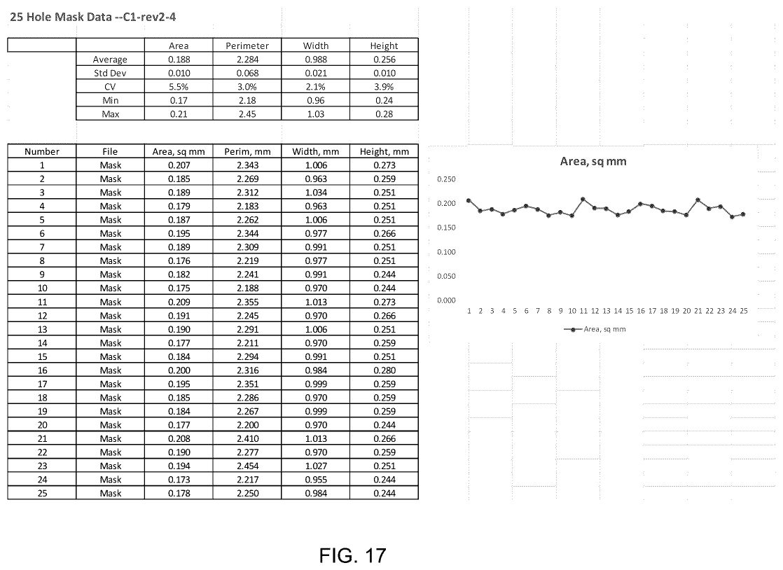

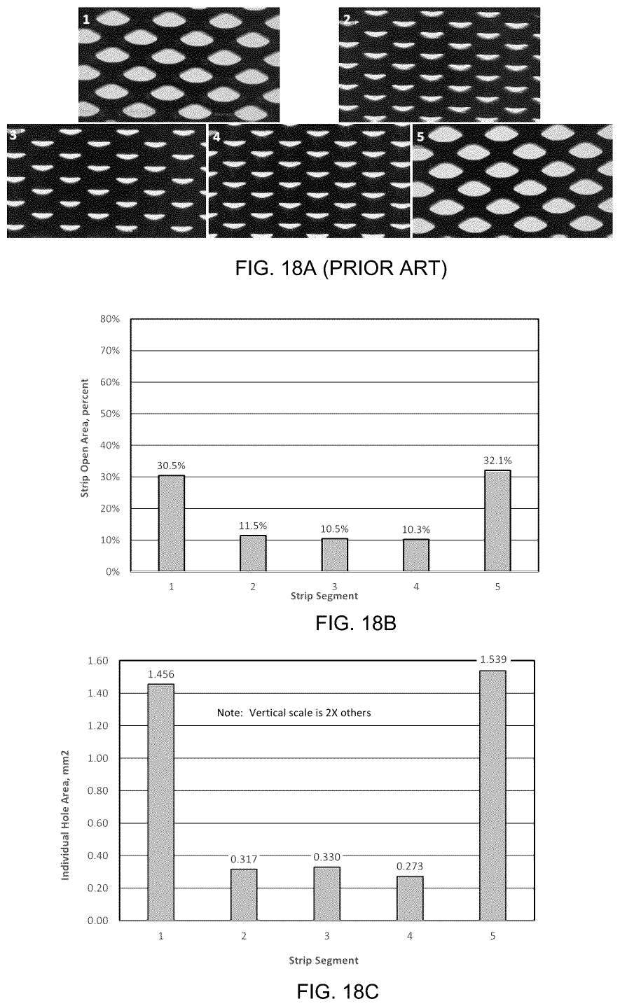

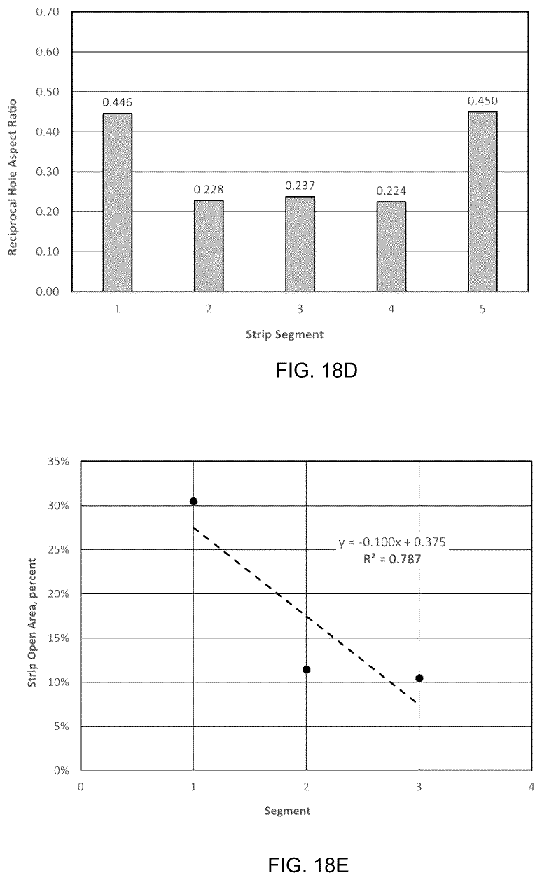

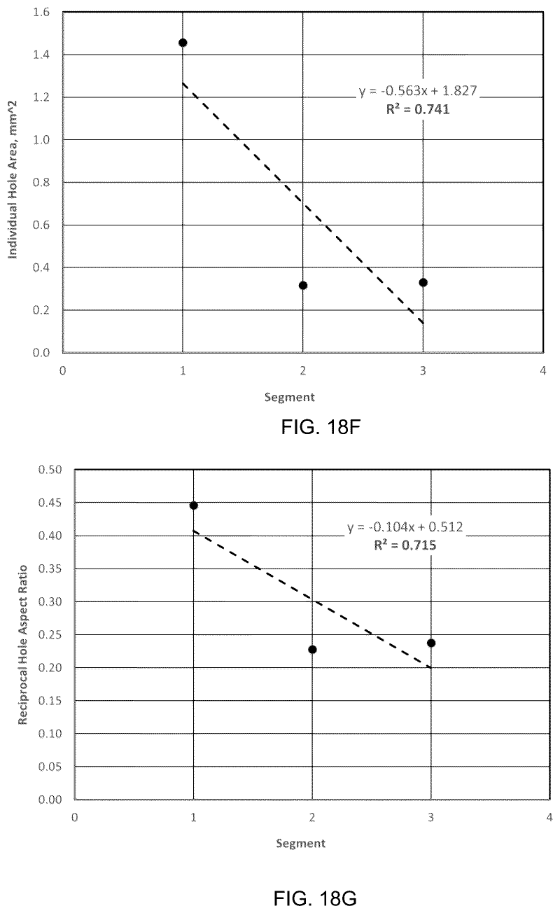

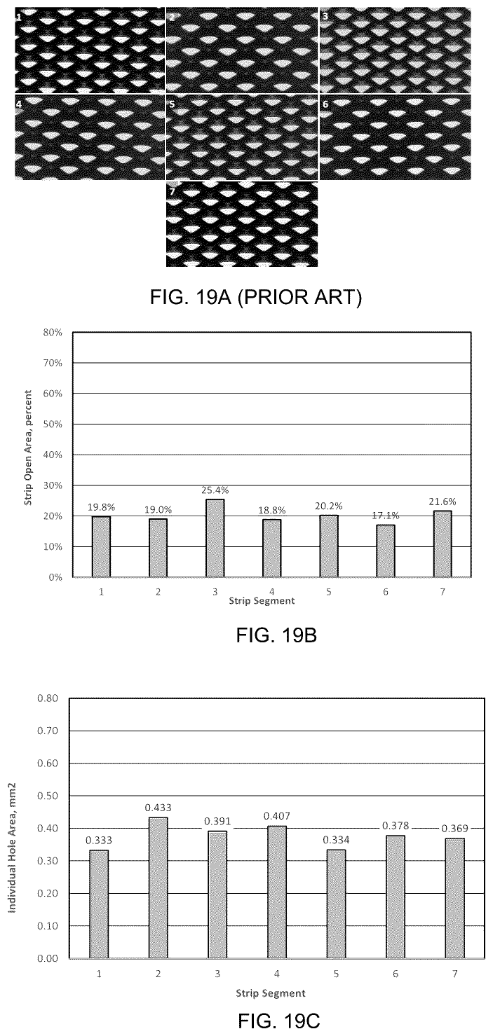

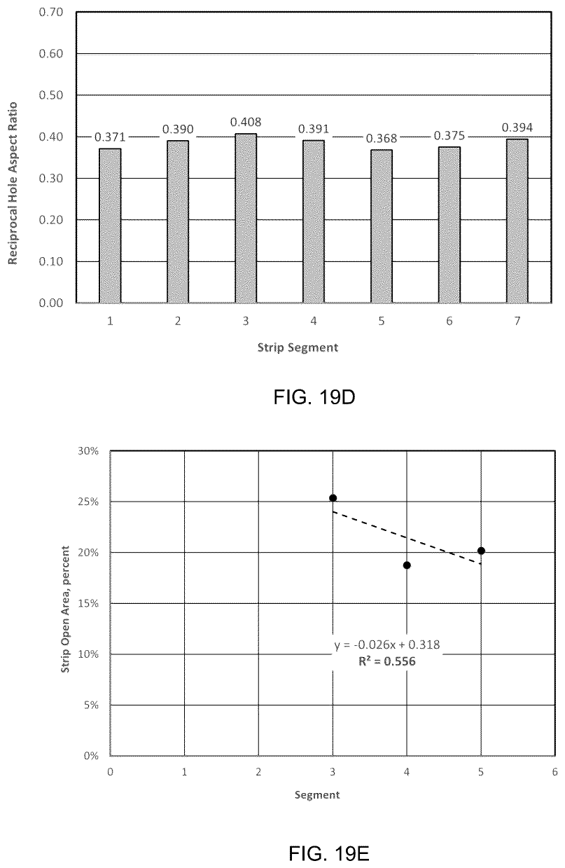

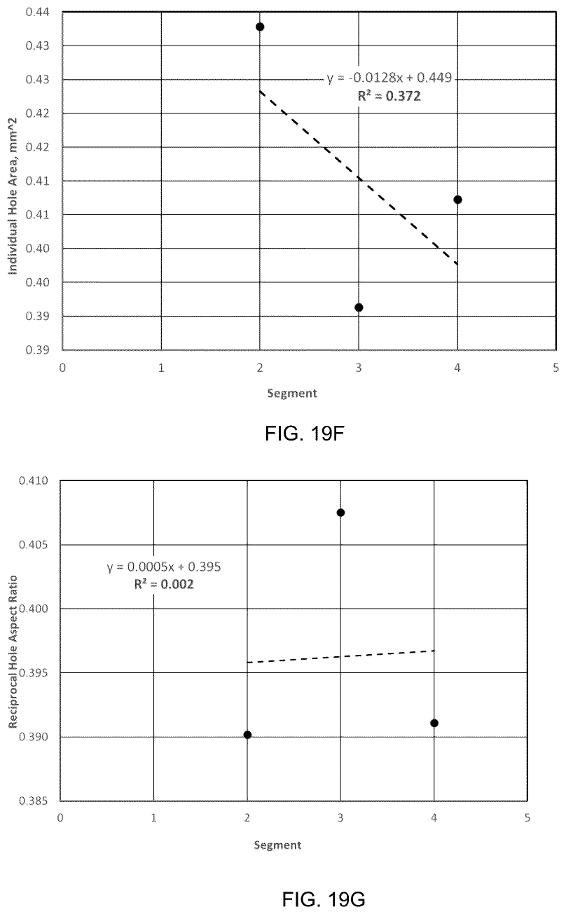

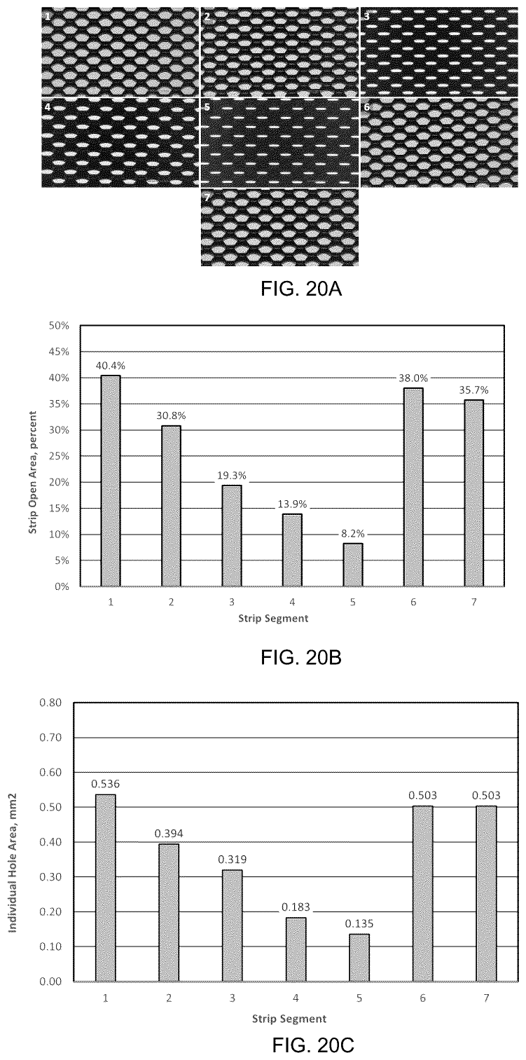

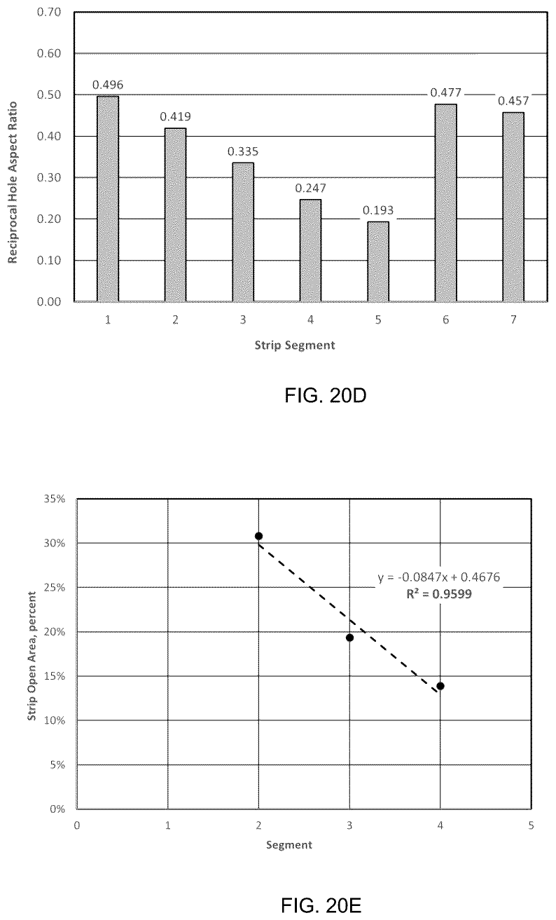

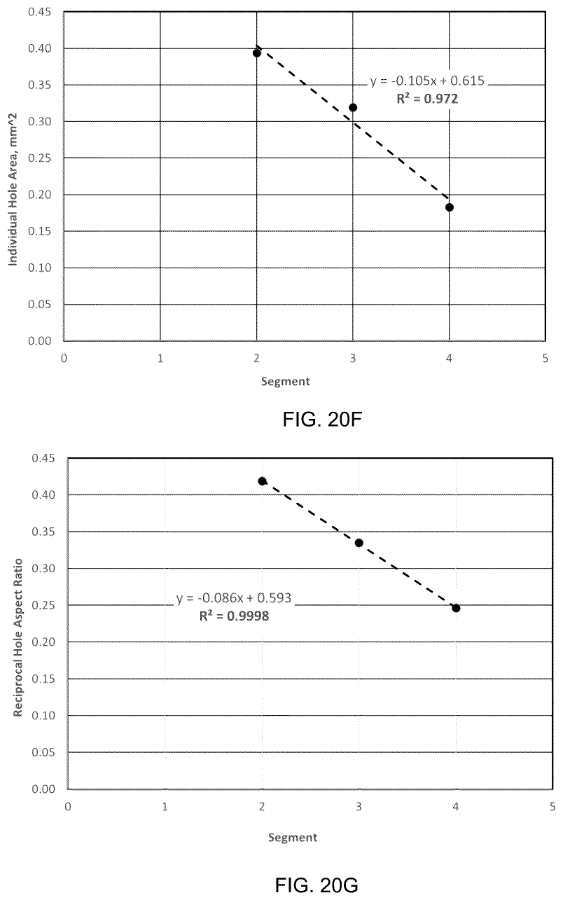

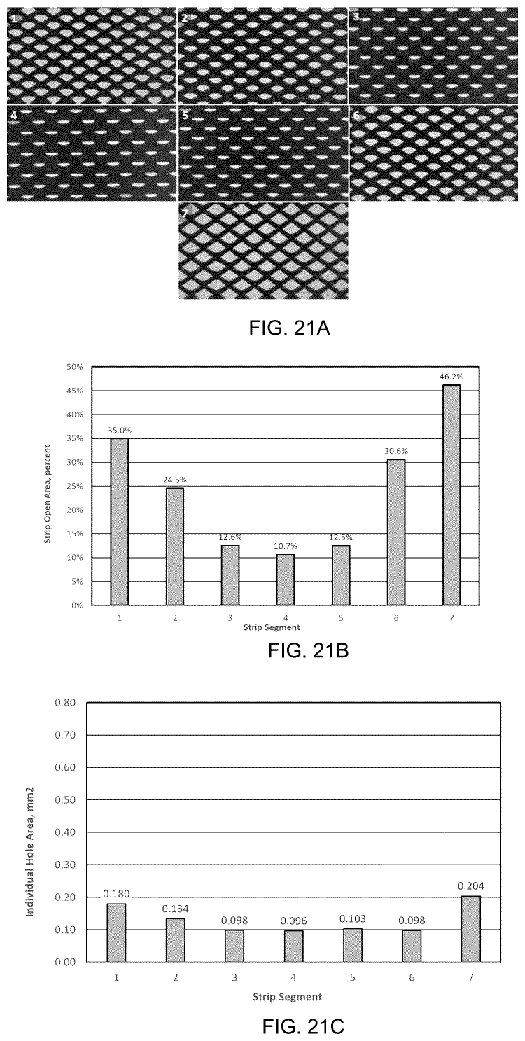

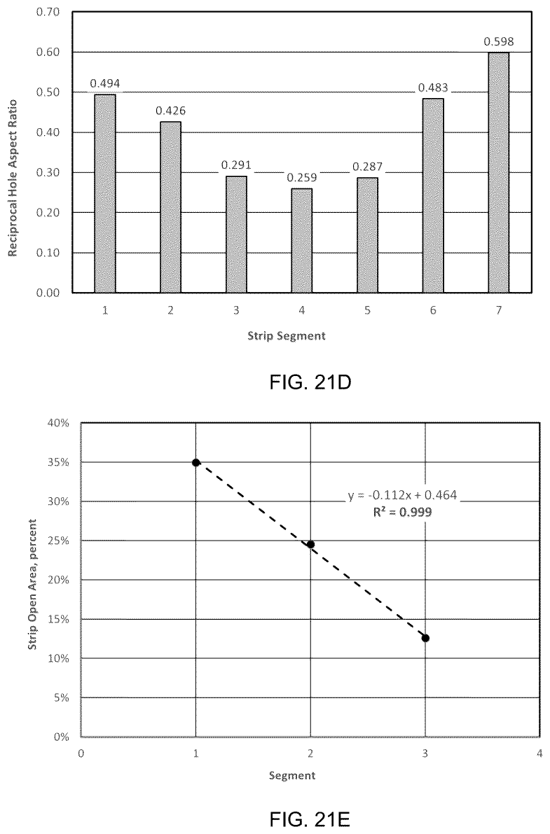

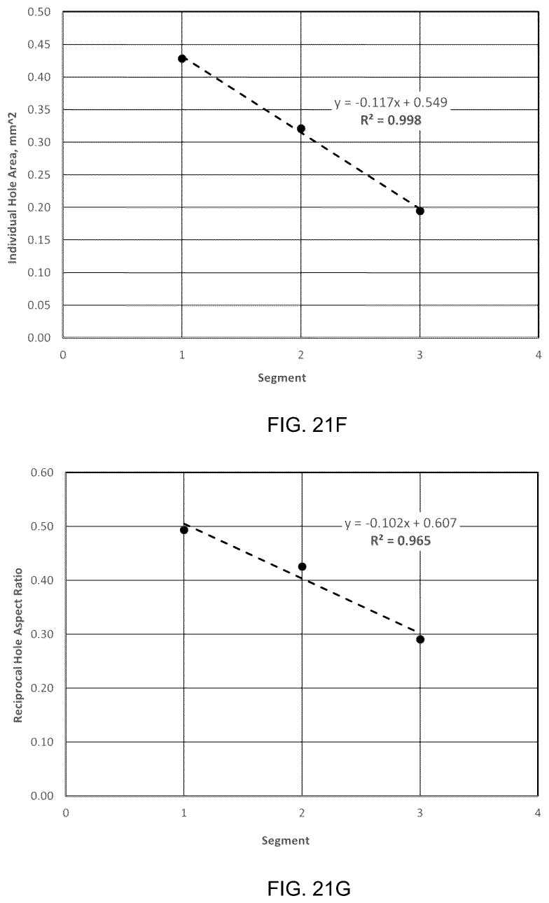

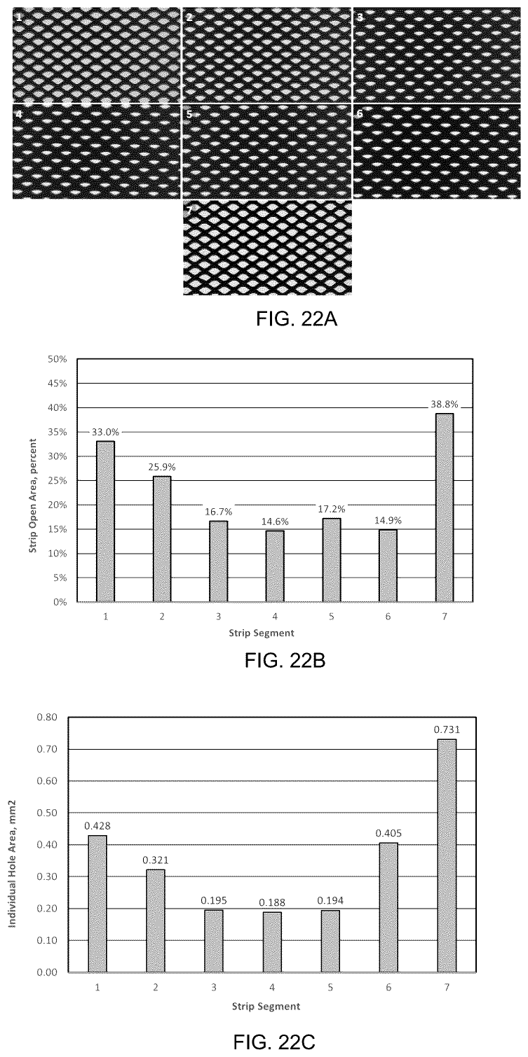

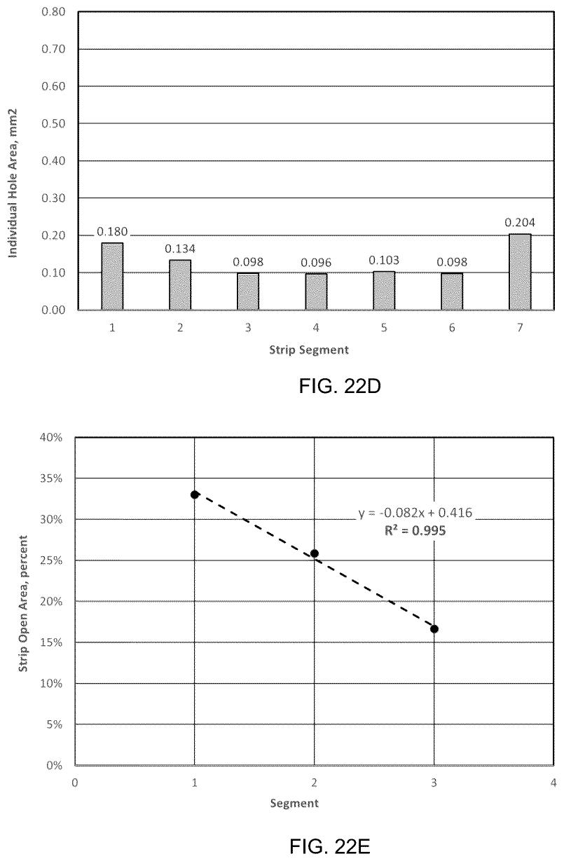

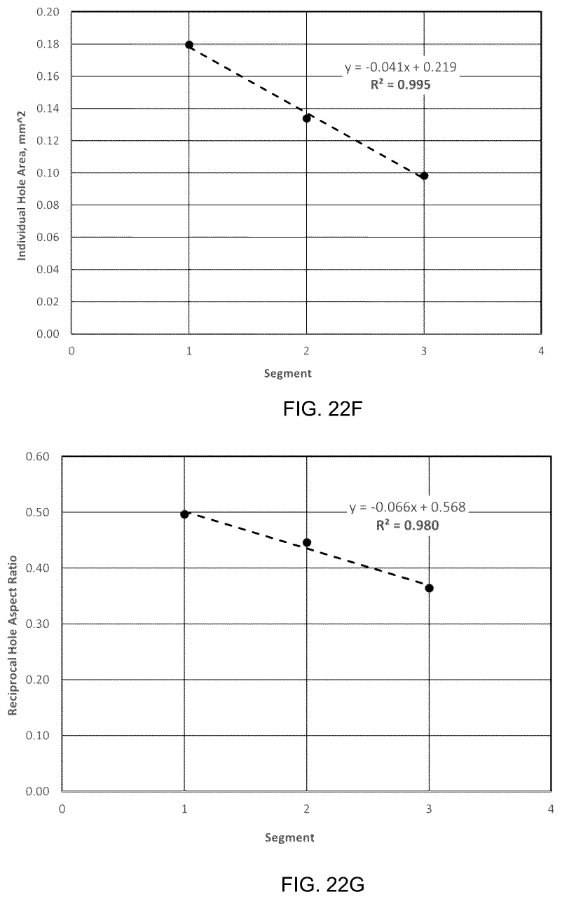

Results are presented in Table and Graph formats as seen in FIGS. 13-17.

Turning back to FIG. 3, the regions making up expanded metal strip 13 form an entrance zone identified as ZONE 1, a nozzle zone identified as ZONE 2, and an optional exit zone identified as ZONE 3. The entrance zone comprises at least two regions and thus at least two layers in the rolled-up filter, the nozzle zone consists of a single region and thus a single layer in the rolled-up filter, and the exit zone, when used, comprises at least two regions and thus at least two layers in the rolled-up filter.

In order to achieve some and preferably all of thin wall thickness, low weight, and small size for a filter, it has been found that: (1) the TOA_{layer} of the single region (layer) of the nozzle zone needs to be smaller than the TOA_{layer} 's of all of the regions (layers) of the entrance zone; (2) for each region (layer) of the entrance and nozzle zones, Sₜᵣₐₙₛᵥₑᵣₛₑ needs to greater than or equal to 4 apertures/cm; and for at least one region (layer) of the entrance zone, D_{layer} needs to be greater than or equal to 67 apertures/cm².

Filters having these characteristics are able to satisfy the demanding performance criteria required of filters for an airbag inflator while having at least one and preferably all of the following properties which previously have not been achieved in the art: (1) a wall thickness t to OD ratio that is less than or equal to 0.07; (2) a wall volume to envelope volume ratio that is less than or equal to 0.30 (or less than or equal to 0.32, or less than or equal to 0.36); and/or (3) an envelope volume to internal volume that is less than or equal to 1.29 (or less than or equal to 1.30, or less than or equal to 1.32, or less than or equal to 1.35), where a cylindrical filter's envelope volume (EV) equals ¼πh OD², its internal volume (IV) equals ¼πh ID², and its wall volume (WV) equals ¼πh (OD²−ID²), where h is the filter's height. The t/OD ratio is a measure of the thinness of the filter's wall; the WV/EV ratio is a measure of the filter's weight with smaller ratios corresponding to lower weights for given materials at a given packing density making up the filter wall; and the EV/IV ratio being a measure of the filter's size with smaller ratios corresponding to smaller sizes for a given amount of solid propellant at a given packing density housed in the filter.

Examples 1-7 herein, set out non-limiting examples of strip prescriptions in accordance with the present disclosure along with their properties, including their t/OD, WV/EV, and EV/IV values. Filters having prescriptions of the type exemplified in Examples 1-7 are able to satisfy the performance criteria required for filters to be used in airbag inflators.

For expanded metal made of Steel and having a thickness of 0.267 mm base and for woven metal mesh, when used, having a 7×7 mm square weave per CM mesh and made of Steel wire having a thickness of near 0.81 mm Filters of the type disclosed in Examples 1-7 having an OD of 55 mm will have weights in the range of 1.3 grams/mm HT to 1.4 grams/mm HT to 1.6 grams/mm HT to 1.8 grams/mm HT. As will be evident to skilled workers, expanded metal strips having different compositions and thicknesses as well as woven metal meshes having different meshes and made from wires having different compositions and thicknesses can be used in the practice of this disclosure.

### EXAMPLES

Without intending to limit its scope in any manner, the disclosure is further illustrated by the following examples.

### Example 1

This example illustrates a filter comprising in order from its ID to its OD: an expanded metal entrance zone (Zone 1), which forms 4 layers of the rolled-up filter, an expanded metal nozzle zone (Zone 2), which forms 1 layer in the rolled-up filter, an expanded metal exit zone (Zone 3), which forms 2 layers in the rolled-up filter, and a wire mesh layer which forms the OD of the rolled-up filter. The three expanded metal zones are made from steel stock having a thickness of 0.27 mm and have the following prescription:

| | | | | |
|---|---|---|---|---|
| S_{longitudinal} | Sₜᵣₐₙₛᵥₑᵣₛₑ | OAₐₚₑᵣₜᵤᵣₑ | | D_{layer} |
| (apertures/ | (apertures/ | (cm²/ | TOA_{layer} | (apertures/ |
| cm) | cm) | aperture) | (%) | cm²) |

Entrance Zone (Zone 1)

| | | | | | |
|---|---|---|---|---|---|
| Layer 1 | 15.0 | 4.9 | 0.0075 | 55.2 | 73.6 |
| Layer 2 | 16.9 | 4.9 | 0.0035 | 29.2 | 83.3 |
| Layer 3 | 11.0 | 4.9 | 0.0025 | 13.6 | 54.3 |
| Layer 4 | 15.7 | 4.9 | 0.0018 | 14.0 | 77.5 |

Nozzle Zone (Zone 2)

| | | | | | |
|---|---|---|---|---|---|
| Single | 10.6 | 4.9 | 0.0008 | 4.2 | 52.0 |
| Layer | | | | | |

Exit Zone (Zone 3)

| | | | | | |
|---|---|---|---|---|---|
| Layer 1 | 14.6 | 4.9 | 0.0051 | 36.9 | 71.7 |
| Layer 2 | 14.9 | 4.9 | 0.0050 | 36.8 | 73.6 |

The rolled-up filter has the following properties:

| | |
|---|---|
| Filter OD (cm) | 55.3 |
| Filter ID (cm) | 50.0 |
| Filter Wall Thickness (t; cm) | 2.65 |
| Filter Height (h; cm) | 40.0 |
| Filter Internal Volume (IV; cm³) | 78500 |
| Filter Envelope Volume (EV; cm³) | 96024 |
| Filter Wall Volume (WV; cm³) | 17524 |
| t/OD ratio | 0.05 |
| WV/EV ratio | 0.18 |
| EV/IV ratio | 1.22 |

When tested, the filter is found to satisfy the performance criteria required for filters to be used in airbag inflators. The filter is suitable for use in airbag inflator assemblies of all types.

### Example 2

This example illustrates a filter comprising in order from its ID to its OD: an expanded metal entrance zone (Zone 1), which forms 5 layers of the rolled-up filter, an expanded metal nozzle zone (Zone 2), which forms 1 layer in the rolled-up filter, an expanded metal exit zone (Zone 3), which forms 1 layer in the rolled-up filter, and a wire mesh layer which forms the OD of the rolled-up filter. The three expanded metal zones are made from steel stock having a thickness of 0.27 mm and have the following prescription:

| | | | | |
|---|---|---|---|---|
| S_{longitudinal} | Sₜᵣₐₙₛᵥₑᵣₛₑ | OAₐₚₑᵣₜᵤᵣₑ | | D_{layer} |
| (apertures/ | (apertures/ | (cm²/ | TOA_{layer} | (apertures/ |
| cm) | cm) | aperture) | (%) | cm²) |

Entrance Zone (Zone 1)

| | | | | | |
|---|---|---|---|---|---|
| Layer 1 | 14.6 | 4.9 | 0.0056 | 40.2 | 71.7 |
| Layer 2 | 16.9 | 4.9 | 0.0040 | 33.3 | 83.3 |
| Layer 3 | 14.5 | 4.9 | 0.0040 | 28.7 | 71.7 |
| Layer 4 | 16.9 | 4.9 | 0.0035 | 25.1 | 71.7 |
| Layer 5 | 14.0 | 4.9 | 0.0056 | 38.5 | 69.0 |

Nozzle Zone (Zone 2)

| | | | | | |
|---|---|---|---|---|---|
| Single | 16.1 | 4.9 | 0.0016 | 12.6 | 79.50 |
| Layer | | | | | |

Exit Zone (Zone 3)

| | | | | | |
|---|---|---|---|---|---|
| Layer 1 | 14.6 | 4.9 | 0.0056 | 40.2 | 71.7 |

The rolled-up filter has the following properties:

| | |
|---|---|
| Filter OD (cm) | 65.0 |
| Filter ID (cm) | 56.4 |
| Filter Wall Thickness (t; cm) | 4.30 |
| Filter Height (h; cm) | 37.0 |
| Filter Internal Volume (IV; cm³) | 92391 |
| Filter Envelope Volume (EV; cm³) | 122715 |
| Filter Wall Volume (WV; cm³) | 30324 |
| t/OD ratio | 0.07 |
| WV/EV ratio | 0.25 |
| EV/IV ratio | 1.33 |

When tested, the filter is found to satisfy the performance criteria required for filters to be used in airbag inflators. The filter is suitable for use in airbag inflator assemblies of all types.

### Example 3

This example illustrates a filter comprising in order from its ID to its OD: an expanded metal entrance zone (Zone 1), which forms 4 layers of the rolled-up filter, an expanded metal nozzle zone (Zone 2), which forms 1 layer in the rolled-up filter, an expanded metal exit zone (Zone 3), which forms 2 layers in the rolled-up filter, and a wire mesh layer which forms the OD of the rolled-up filter. The three expanded metal zones are made from steel stock having a thickness of 0.27 mm and have the following prescription:

| | | | | |
|---|---|---|---|---|
| S_{longitudinal} | Sₜᵣₐₙₛᵥₑᵣₛₑ | OAₐₚₑᵣₜᵤᵣₑ | | D_{layer} |
| (apertures/ | (apertures/ | (cm²/ | TOA_{layer} | (apertures/ |
| cm) | cm) | aperture) | (%) | cm²) |

Entrance Zone (Zone 1)

| | | | | | |
|---|---|---|---|---|---|
| Layer 1 | 14.2 | 4.9 | 0.0068 | 47.4 | 69.8 |
| Layer 2 | 15.7 | 4.9 | 0.0040 | 31.0 | 77.0 |
| Layer 3 | 12.2 | 4.9 | 0.0030 | 18.0 | 60.0 |
| Layer 4 | 15.7 | 4.9 | 0.0018 | 14.0 | 77.5 |

Nozzle Zone (Zone 2)

| | | | | | |
|---|---|---|---|---|---|
| Single | 11.8 | 4.9 | 0.0010 | 6.3 | 58.0 |
| Layer | | | | | |

Exit Zone (Zone 3)

| | | | | | |
|---|---|---|---|---|---|
| Layer 1 | 15.7 | 4.9 | 0.0051 | 39.5 | 77.5 |
| Layer 2 | 13.4 | 4.9 | 0.0050 | 32.9 | 65.9 |

The rolled-up filter has the following properties:

| | |
|---|---|
| Filter OD (cm) | 57.0 |
| Filter ID (cm) | 50.7 |
| Filter Wall Thickness (t; cm) | 3.15 |
| Filter Height (h; cm) | 38.0 |
| Filter Internal Volume (IV; cm³) | 76678 |
| Filter Envelope Volume (EV; cm³) | 96918 |
| Filter Wall Volume (WV; cm³) | 20240 |
| t/OD ratio | 0.06 |
| WV/EV ratio | 0.21 |
| EV/IV ratio | 1.26 |

When tested, the filter is found to satisfy the performance criteria required for filters to be used in airbag inflators. The filter is suitable for use in airbag inflator assemblies of all types.

### Example 4

This example illustrates a filter comprising in order from its ID to its OD: an expanded metal entrance zone (Zone 1), which forms 4 layers of the rolled-up filter, an expanded metal nozzle zone (Zone 2), which forms 1 layer in the rolled-up filter, an expanded metal exit zone (Zone 3), which forms 2 layers in the rolled-up filter, and a wire mesh layer which forms the OD of the rolled-up filter. The three expanded metal zones are made from steel stock having a thickness of 0.27 mm and have the following prescription:

| | | | | |
|---|---|---|---|---|
| S_{longitudinal} | Sₜᵣₐₙₛᵥₑᵣₛₑ | OAₐₚₑᵣₜᵤᵣₑ | | D_{layer} |
| (apertures/ | (apertures/ | (cm²/ | TOA_{layer} | (apertures/ |
| cm) | cm) | aperture) | (%) | cm²) |

Entrance Zone (Zone 1)

| | | | | | |
|---|---|---|---|---|---|
| Layer 1 | 13.4 | 7.9 | 0.0047 | 49.6 | 105.4 |
| Layer 2 | 15.7 | 7.9 | 0.0035 | 43.4 | 124.0 |
| Layer 3 | 12.6 | 7.9 | 0.0030 | 28.8 | 96.1 |
| Layer 4 | 15.7 | 7.9 | 0.0010 | 12.4 | 124.0 |

Nozzle Zone (Zone 2)

| | | | | | |
|---|---|---|---|---|---|
| Single | 11.8 | 7.9 | 0.0010 | 9.3 | 93.0 |
| Layer | | | | | |

Exit Zone (Zone 3)

| | | | | | |
|---|---|---|---|---|---|
| Layer 1 | 15.7 | 7.9 | 0.0040 | 49.6 | 124.0 |
| Layer 2 | 13.4 | 7.9 | 0.0045 | 47.4 | 105.4 |

The rolled-up filter has the following properties:

| | |
|---|---|
| Filter OD (cm) | 49.0 |
| Filter ID (cm) | 42.6 |
| Filter Wall Thickness (t; cm) | 3.20 |
| Filter Height (h; cm) | 25.0 |
| Filter Internal Volume (IV; cm³) | 35615 |
| Filter Envelope Volume (EV; cm³) | 47120 |
| Filter Wall Volume (WV; cm³) | 11505 |
| t/OD ratio | 0.07 |
| WV/EV ratio | 0.24 |
| EV/IV ratio | 1.32 |

When tested, the filter is found to satisfy the performance criteria required for filters to be used in airbag inflators. The filter is suitable for use in airbag inflator assemblies of all types.

### Example 5

This example illustrates a filter comprising in order from its ID to its OD: an expanded metal entrance zone (Zone 1), which forms 4 layers of the rolled-up filter, an expanded metal nozzle zone (Zone 2), which forms 1 layer in the rolled-up filter, an expanded metal exit zone (Zone 3), which forms 1 layer in the rolled-up filter, and a wire mesh layer which forms the OD of the rolled-up filter. The three expanded metal zones are made from steel stock having a thickness of 0.27 mm and have the following prescription:

| | | | | |
|---|---|---|---|---|
| S_{longitudinal} | Sₜᵣₐₙₛᵥₑᵣₛₑ | OAₐₚₑᵣₜᵤᵣₑ | | D_{layer} |
| (apertures/ | (apertures/ | (cm²/ | TOA_{layer} | (apertures/ |
| cm) | cm) | aperture) | (%) | cm²) |

Entrance Zone (Zone 1)

| | | | | | |
|---|---|---|---|---|---|
| Layer 1 | 14.9 | 7.9 | 0.0038 | 44.8 | 118.0 |
| Layer 2 | 16.9 | 7.9 | 0.0023 | 30.7 | 133.3 |
| Layer 3 | 11.0 | 7.9 | 0.0023 | 20.0 | 86.8 |
| Layer 4 | 15.7 | 7.9 | 0.0010 | 12.0 | 124.0 |

Nozzle Zone (Zone 2)

| | | | | | |
|---|---|---|---|---|---|
| Single | 10.6 | 7.9 | 0.0008 | 6.7 | 84.0 |
| Layer | | | | | |

Exit Zone (Zone 3)

| | | | | | |
|---|---|---|---|---|---|
| Layer 1 | 14.9 | 7.9 | 0.0030 | 35.3 | 117.8 |

The rolled-up filter has the following properties:

| | |
|---|---|
| Filter OD (cm) | 57.0 |
| Filter ID (cm) | 52.0 |
| Filter Wall Thickness (t; cm) | 2.50 |
| Filter Height (h; cm) | 30.0 |
| Filter Internal Volume (IV; cm³) | 63679 |
| Filter Envelope Volume (EV; cm³) | 76514 |
| Filter Wall Volume (WV; cm³) | 12835 |
| t/OD ratio | 0.04 |
| WV/EV ratio | 0.17 |
| EV/IV ratio | 1.20 |

When tested, the filter is found to satisfy the performance criteria required for filters to be used in airbag inflators. The filter is suitable for use in airbag inflator assemblies of all types.

### Example 6

This example illustrates a filter comprising in order from its ID to its OD: an expanded metal entrance zone (Zone 1), which forms 4 layers of the rolled-up filter, an expanded metal nozzle zone (Zone 2), which forms 1 layer in the rolled-up filter, an expanded metal exit zone (Zone 3), which forms 1 layer in the rolled-up filter, and a wire mesh layer which forms the OD of the rolled-up filter. The three expanded metal zones are made from steel stock having a thickness of 0.27 mm and have the following prescription:

| | | | | |
|---|---|---|---|---|
| S_{longitudinal} | Sₜᵣₐₙₛᵥₑᵣₛₑ | OAₐₚₑᵣₜᵤᵣₑ | | D_{layer} |
| (apertures/ | (apertures/ | (cm²/ | TOA_{layer} | (apertures/ |
| cm) | cm) | aperture) | (%) | cm²) |

Entrance Zone (Zone 1)

| | | | | | |
|---|---|---|---|---|---|
| Layer 1 | 9.8 | 7.9 | 0.0050 | 38.8 | 77.5 |
| Layer 2 | 14.1 | 7.9 | 0.0042 | 46.9 | 111.6 |
| Layer 3 | 11.0 | 7.9 | 0.0042 | 36.5 | 86.8 |
| Layer 4 | 14.9 | 7.9 | 0.0023 | 27.1 | 117.0 |

Nozzle Zone (Zone 2)

| | | | | | |
|---|---|---|---|---|---|
| Single | 12.2 | 7.9 | 0.0007 | 6.7 | 96.0 |
| Layer | | | | | |

Exit Zone (Zone 3)

| | | | | | |
|---|---|---|---|---|---|
| Layer 1 | 16.1 | 7.9 | 0.0030 | 38.1 | 127.1 |

The rolled-up filter has the following properties:

| | |
|---|---|
| Filter OD (cm) | 46.0 |
| Filter ID (cm) | 41.0 |
| Filter Wall Thickness (t; cm) | 2.50 |
| Filter Height (h; cm) | 32.0 |
| Filter Internal Volume (IV; cm³) | 42227 |
| Filter Envelope Volume (EV; cm³) | 53154 |
| Filter Wall Volume (WV; cm³) | 10927 |
| t/OD ratio | 0.05 |
| WV/EV ratio | 0.21 |
| EV/IV ratio | 1.26 |

When tested, the filter is found to satisfy the performance criteria required for filters to be used in airbag inflators. The filter is suitable for use in airbag inflator assemblies of all types.

### Example 7

This example illustrates a filter comprising in order from its ID to its OD: an expanded metal entrance zone (Zone 1), which forms 2 layers of the rolled-up filter, an expanded metal nozzle zone (Zone 2), which forms 1 layer in the rolled-up filter, and a wire mesh layer which forms the OD of the rolled-up filter. The two expanded metal zones are made from steel stock having a thickness of 0.27 mm and have the following prescription:

| | | | | |
|---|---|---|---|---|
| S_{longitudinal} | Sₜᵣₐₙₛᵥₑᵣₛₑ | OAₐₚₑᵣₜᵤᵣₑ | | D_{layer} |
| (apertures/ | (apertures/ | (cm²/ | TOA_{layer} | (apertures/ |
| cm) | cm) | aperture) | (%) | cm²) |

Entrance Zone (Zone 1)

| | | | | | |
|---|---|---|---|---|---|
| Layer 1 | 11.8 | 7.9 | 0.0019 | 17.7 | 93.0 |
| Layer 2 | 11.8 | 7.9 | 0.0016 | 14.9 | 93.0 |

Nozzle Zone (Zone 2)

| | | | | | |
|---|---|---|---|---|---|
| Single | 9.8 | 7.9 | 0.0010 | 7.8 | 78.0 |
| Layer | | | | | |

The rolled-up filter has the following properties:

| | |
|---|---|
| Filter OD (cm) | 52.5 |
| Filter ID (cm) | 48.5 |
| Filter Wall Thickness (t; cm) | 2.00 |
| Filter Height (h; cm) | 28.0 |
| Filter Internal Volume (IV; cm³) | 51702 |
| Filter Envelope Volume (EV; cm³) | 60582 |
| Filter Wall Volume (WV; cm³) | 8880 |
| t/OD ratio | 0.04 |
| WV/EV ratio | 0.15 |
| EV/IV ratio | 1.17 |

When tested, the filter is found to satisfy the performance criteria required for filters to be used in airbag inflators. The filter is suitable for use in airbag inflator assemblies of all types.

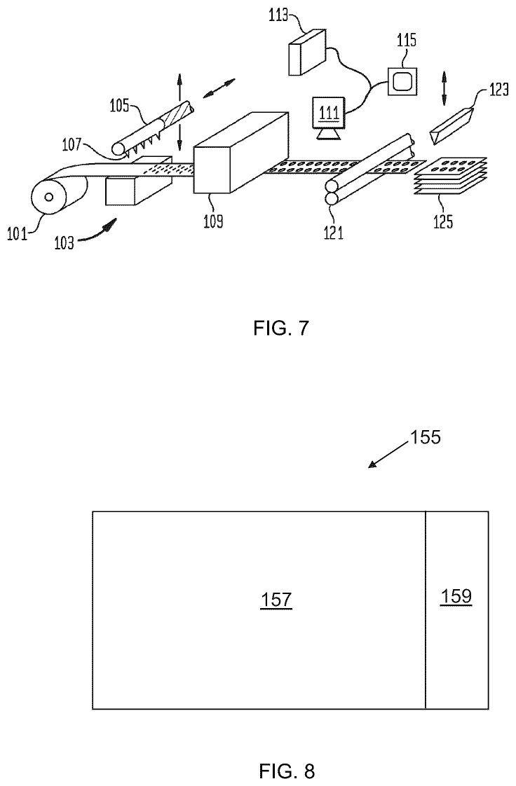

With reference now to FIG. 7, the manufacture of an expanded metal strip according to certain aspects of this disclosure starts with a roll of metal sheet 101. For filters for airbag inflators, stainless steel, such as SS304, 309, 310, 409, 410, or 430 can be used. Carbon steel from C1006 to C1008 is often preferred for various applications. Depending on the environment in which the expanded metal is used, other metal compositions available in a sheet form can be used. In an embodiment, the thickness of the sheet metal from which the expanded metal is produced is less than or equal to 0.25 mm (or less than or equal to 0.27 mm, or less than or equal to 0.28 mm)

For embodiments in which the filter has an outer layer composed of woven metal mesh, the wire making up the mesh can have compositions like those listed above for the expanded metal sheet. The expanded metal and wire mesh in some embodiments will have the same composition and in other embodiments, the two components will have different compositions. The woven wire mesh can have the following characteristics: a mesh density of 7×7 (or 9×9, or hybrid 7×9) and a wire thickness of 0.43 mm (or 0.48 mm, or 0.53 mm). The layer of woven metal mesh can provide a gas flow plenum outside the expanded metal layers. Because the wires of the mesh are woven on top and underneath one another, they provide a mechanical benefit in that they will not collapse even under extreme loading conditions. The mesh will thus allow gas flow outside the filter even if the filter loses all hoop strength and presses against the inflator's metal housing or a bonded seal foil.

Returning to FIG. 7, the sheet is fed first to a press 103 in which a punch 105 having a number of teeth or bits 107 is moved into the sheet so that the teeth perforate the sheet and then the punch is removed, just as in a stamping operation. The geometry of the bits, which are preferably identical to each other, is preferably such that a slit is formed in the sheet. Depending on the geometry of the bit, the depth of penetration of the bit will determine the length of the slit formed; the deeper the penetration, the longer the slit, and thus the more open the final structure can be after stretching. While shown with a single punch, multiple punches can be used to provide different perforation spacings, geometries, and/or depths. For airbag inflator filters, the opening is made to a size based on the airbag manufacturer's specifications for the open area of the sheet, the porosity of the sheet, or other parameter(s) required for the filter.

The sheet is advanced preferably by a servo motor (not shown) or other mechanism whereby the longitudinal advance of the sheet can be precisely controlled. The advance of the sheet is preferably in discrete steps so that the sheet is stationary when punched. Although not preferred, a roller with teeth can be used in a continuously moved sheet.

The perforated sheet produced in the press is then fed to a stretcher 109 in which differential rollers stretch the perforated sheet in the axial direction (that is, along the direction of travel) so that the slits are opened into diamond-shaped apertures. (Of course, a hexagonal bit can be used to make hexagonal openings, or other bit geometries, can be used, but slits formed into diamonds is a common shape.)

Although slitting and stretching can be performed as separate operations, when fine patterns are to be formed, it is often preferable to produce the expanded metal sheets by performing slitting and stretching with the same teeth in the same motion. During this operation, the material hangs out over a flattened bottom blade and angled upper teeth or bits slit the sheet and then continue into the sheet. The sheet bends down and the angle formed by this bending as it relates to the teeth causes a stretching motion of the sheet. Consequently, the sheet is stretched more or less by the depth of the tooth penetrations. The amount of stretching achieved in this way is typically in the range of 20-25% and can be as much as 37%. Compared to the slit-and-stretch approach, the one step approach produces perforations that have a shape more like that of a triangle than a diamond. As with the separate slitting and stretching approach, the one step approach forms apertures by (i) forming slits in a sheet of metal and (ii) stretching the slits in the direction of the metal's longitudinal axis, but does so in one step, rather than two.

Once formed, the expanded metal sheet can be flattened by, for example, one or a pair 121 of rollers. If desired, the expanded metal sheet can be passed through multiple pairs of rollers to achieve the desired degree of flattening. The expanded metal sheet can be cut into pieces 125 of a desired shape for further processing using cutters such as cutter 123 shown in FIG. 7. The further processing can comprise rolling into a substantially cylindrical shape, with spot welds being used at the leading and trailing edges of the strip to hold the strip in its rolled configuration. The further processing can also include welding of the expanded metal strip to a section of woven metal mesh (when used) prior to rolling and spot welding of the leading and trailing edges.

A video control system can be used to control the manufacturing of the expanded metal strips. It can include at least one camera 111, which is connected with a computer controller 113 running software, and an optional monitor 115, to examine the apertures or open area, and thereby learn (after parameters are input to the controller) whether the perforations in the sheet are within specification. The controller's software checks the opening sizes and/or shapes (geometry) to determine whether the individual openings, or open area (actual or estimated or calculated), are within specification. Additional cameras (not shown) can be placed between the punch and the stretcher to determine whether the initial punching is within specification, as well as after the flattening rollers to determine if the desired degree of flattening has been achieved. The video control system performs an optical inspection of the expanded metal sheet product and determines whether the product is within specification. To alter the process to get on, return to, or change the specification, the advance of the sheet can be altered by adjusting the servo motor (via the computer controller) to change the longitudinal spacing of the perforations. The stretcher can also be adjusted to increase or decrease the amount the perforated sheet is stretched.

In an embodiment, the expanded metal strip is a strip of variable expanded metal (VEM) in accordance with commonly-assigned U.S. Pat. No. 10,717,032, the contents of which in their entirety are incorporated herein by reference. Preferably, the filter comprises just an expanded metal strip and, when used, an attached woven wire mesh layer, and does not include one or more layers or sections of other materials such as metal screens, ceramic fabrics, or the like. The filters of Table 1 are of this type where the only components of the filter are expanded metal and woven wire mesh in those embodiments that use woven wire mesh. However, if desired, additional materials can be included in the filter.

Once completed, the filter can be installed within a housing having a plurality of apertures which allow gases produced by the burning of the inflator's solid propellant to exit the housing and inflate the air bag which is secured about the outside of the housing. FIG. 8 is a schematic diagram showing the overall construction of an airbag assembly 155 comprising an inflator 157 which includes a filter which houses a solid propellant which when burned inflates an airbag or, in more general terms, an inflatable vehicle occupant protection device 159.

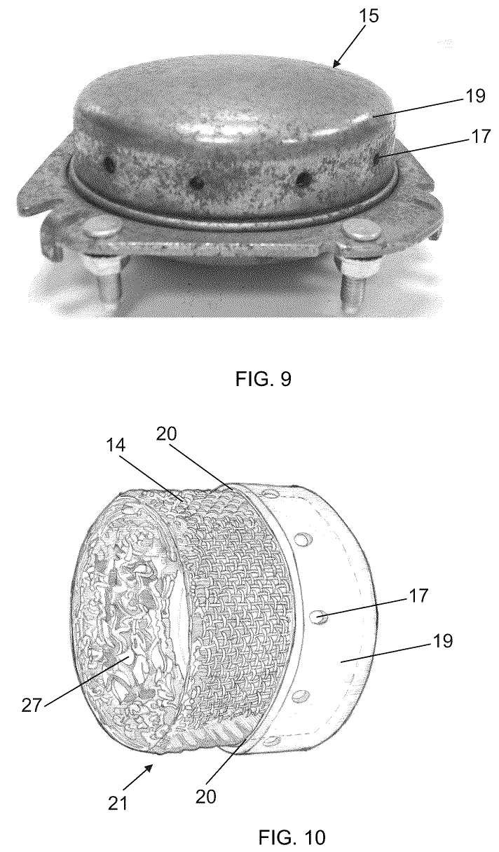

FIG. 9 is a photograph of an embodiment of a housing 15 that can be used with the filters disclosed herein. The housing includes an upper portion 19 which includes apertures 17 which allow the inflation gases to enter the airbag after passing through the filter. It has been surprisingly found that unlike prior art expanded metal filters, the filters disclosed herein and, in particular, filters having an outer layer formed of woven metal mesh, are so robust that they can be removed with ease (manually separated) from their housings even after experiencing the high forces associated with the rapid burning of the inflator's solid propellant. In many cases, the filters will simply fall out of their housings when the housings are turned upside down.

FIG. 10 illustrates this feature. As shown in this figure, even after the rapid burning of the solid propellant, thin gaps 20 remain between woven metal mesh 14 and the upper portion 19 of the filter's housing which permit the ready removable of a used filter from the housing. This easy removability is especially surprising in view of the fact that the walls of the filters disclosed herein are thin, which would suggest more deformation by the forces generated by the rapid burning of the solid propellant and thus more bonding with the filter's housing, not less bonding or, in many cases, essentially no bonding with the housing.

The robustness of the filters disclosed herein is particularly surprising in view of the fact that the expanded metal can be made from thin stock material having a low tensile strength. It was previously thought that such stock material would not be suitable for use in filters and, in particular, in filters for airbag inflators. Although not wishing to be bound by any particular theory of operation, it is believed that the use of such materials is made possible through the filter's thermodynamic and gas flow properties of the filter resulting from the structure of the filter's entrance zone, nozzle zone, and exit zone, with the structure of the entrance zone and nozzle zone being most important.

Regarding thermodynamics, by having the TOA_{layer} of the single layer of the nozzle zone smaller than the TOA_{layer}'s of all of the layers of the entrance zone, the overall open area shape of the intake to the filter is inwardly-funneling. This inwardly-funneling shape facilitates thermodynamic cooling of the gases passing through the filter, thus reducing the need for high levels of heat transfer from the gases to the mass of the filter. This, in turn, allows the filter to have less mass (less weight), while still achieving the high level of cooling required for filters for airbag inflators. The ability to achieve a high level of cooling with a reduced filter mass allows the expanded metal to be made from thinner stock. The exit zone, when used, further facilitates the thermodynamic cooling by having an outwardly-funneling shape as a result of the TOA_{layer} 's of all its layers being larger than the TOA_{layer} of the single layer of the nozzle zone. This entrance zone/nozzle zone/exit zone combination results in an overall TOA_{layer} profile that starts large (entrance zone), necks down to small (nozzle zone), and then expands to large (exit zone), which is especially effective in achieving thermodynamic cooling and thereby reducing the need for a heavy (high mass) filter.

The structure of the filter's entrance zone, nozzle zone, and exit zone (when used) also allow the filter to have a low level of backpressure. In each of these zones, the apertures are arranged so that Sₜᵣₐₙₛᵥₑᵣₛₑ is greater than or equal to 4 apertures/cm. Also, at least one layer of the entrance zone has a D_{layer} greater than or equal to 67 apertures/cm². This high D_{layer} value leads to improved capture of the slag produced by the rapid burning of the inflator's solid propellant, as well as to more efficient cooling. Further, the larger TOA_{layer}'s of the entrance zone means that the entrance zone preferentially captures large particles in the gas stream which if passed through to the nozzle zone could clog that zone thus increasing the filter's backpressure. By the combination of these structural features, gas flow through the filter is facilitated, thus reducing the filter's backpressure. This reduced backpressure, in turn, reduces the forces that the filter must withstanding during the rapid burning of the solid propellant thus allowing the filter to be composed of weaker materials.

Another measure of defining the improved configuration of the present thin-walled filters is by comparing TOA of the successive layers of the zones wherein there is an Entrance Zone (Zone 1), a Nozzle Zone (Zone 2) and an Exit Zone (Zone 3). A critical aspect of designing the successive layers of the zone is to have a plurality of layers in the Entrance Zone leading up to the Nozzle Zone to have monotonically decreasing Open Areas (OAa). The relationship of the layers and zones is best described below wherein;

An exemplary filter comprises
a strip of expanded metal rolled-up about an axis to form multiple layers, said strip of expanded metal having a longitudinal axis and a transverse axis and comprising a plurality of apertures arranged in rows oriented perpendicular to the longitudinal axis, the strip being rolled up along the longitudinal axis to form the filter, wherein:
(I) the rolled-up filter has an inner surface and an outer surface;
(II) each of the filter's layers comprises a plurality of apertures having an average open area OA;
(III) the strip of expanded metal comprises an entrance zone which forms a plurality of layers in the rolled-up filter and a nozzle zone which forms a single layer in the rolled-up filter, the entrance zone being adjacent to the nozzle zone with the entrance zone being closer to the inner surface of the rolled-up filter than the nozzle zone;
(IV) the OA of the single layer of the nozzle zone is smaller than the OAs of all of the layers of the entrance zone; and
(V) the plurality of layers of the entrance zone comprises a set of at least three adjacent layers characterized by:
(a) the set's OAs monotonically decrease from the layer closest to the inner surface to the layer closest to the outer surface; and
(b) a linear fit to the set's OAs has a R-squared value of at least 0.80.

The filter further characterized wherein the magnitude of the slope of the linear fit is at least 0.04 square millimeters per layer.

The filter further characterized wherein the inner surface of the rolled-up filter has an average diameter ID, the outer surface has an average diameter OD, and the filter has an average wall thickness t given by:

$$t = 1 / 2 ( OD - ID ) ,$$

$$where :$$

$$t / OD \leq 0.07 .$$

Another exemplary filter comprises
a strip of expanded metal rolled-up about an axis to form multiple layers, said strip of expanded metal having a longitudinal axis and a transverse axis and comprising a plurality of apertures arranged in rows oriented perpendicular to the longitudinal axis, the strip being rolled up along the longitudinal axis to form the filter, wherein:
(I) the rolled-up filter has an inner surface and an outer surface;
(II) each of the filter's layers comprises a plurality of apertures having an average longitudinal dimension LD;
(III) the strip of expanded metal comprises an entrance zone which forms a plurality of layers in the rolled-up filter and a nozzle zone which forms a single layer in the rolled-up filter, the entrance zone being adjacent to the nozzle zone with the entrance zone being closer to the inner surface of the rolled-up filter than the nozzle zone;
(IV) the LD of the single layer of the nozzle zone is smaller than the LDs of all of the layers of the entrance zone; and
(V) the plurality of layers of the entrance zone comprises a set of at least three adjacent layers characterized by:
(a) the set's LDs monotonically decrease from the layer closest to the inner surface to the layer closest to the outer surface; and
(b) a linear fit to the set's LDs has a R-squared value of at least 0.8.

The filter is further characterized wherein the magnitude of the slope of the linear fit is at least 0.04 millimeters per layer.

The filter is further characterized wherein the inner surface of the rolled-up filter has an average diameter ID, the outer surface has an average diameter OD, and the filter has an average wall thickness t given by:

$$t = 1 / 2 ( OD - ID ) ,$$

$$where :$$

$$t / OD \leq 0.07 .$$

Still another exemplary filter comprises
a strip of expanded metal rolled-up about an axis to form multiple layers, said strip of expanded metal having a longitudinal axis and a transverse axis and comprising a plurality of apertures arranged in rows oriented perpendicular to the longitudinal axis, the strip being rolled up along the longitudinal axis to form the filter, wherein:
(I) the rolled-up filter has an inner surface and an outer surface;
(II) each of the filter's layers comprises a plurality of apertures having an average transverse to longitudinal aspect ratio AR;
(III) the strip of expanded metal comprises an entrance zone which forms a plurality of layers in the rolled-up filter and a nozzle zone which forms a single layer in the rolled-up filter, the entrance zone being adjacent to the nozzle zone with the entrance zone being closer to the inner surface of the rolled-up filter than the nozzle zone;
(IV) the AR of the single layer of the nozzle zone is larger than the ARs of all of the layers of the entrance zone; and
(V) the plurality of layers of the entrance zone comprises a set of at least three adjacent layers characterized by:
(a) the set's ARs monotonically increase from the layer closest to the inner surface to the layer closest to the outer surface; and
(b) a linear fit to the set's ARs has a R-squared value of at least 0.8.

The filter is further characterized wherein the magnitude of the slope of the linear fit is at least 0.04 per layer.

The filter is characterized wherein the inner surface of the rolled-up filter has an average diameter ID, the outer surface has an average diameter OD, and the filter has an average wall thickness t given by:

$$t = 1 / 2 ( OD - ID ) ,$$

$$where :$$

$$t / OD \leq 0.07 .$$

Yet another filter comprises
a strip of expanded metal rolled-up about an axis to form multiple layers, said strip of expanded metal having a longitudinal axis and a transverse axis and comprising a plurality of apertures arranged in rows oriented perpendicular to the longitudinal axis, the strip being rolled up along the longitudinal axis to form the filter, wherein:
(I) the rolled-up filter has an inner surface and an outer surface;
(II) each of the filter's layers has an average percent open area POA;
(III) the strip of expanded metal comprises an entrance zone which forms at least three layers in the rolled-up filter and a nozzle zone which forms a single layer in the rolled-up filter, the entrance zone being adjacent to the nozzle zone with the entrance zone being closer to the inner surface of the rolled-up filter than the nozzle zone;
(IV) the POA of the single layer of the nozzle zone is smaller than the POAs of all of the layers of the entrance zone; and
(V) the plurality of layers of the entrance zone comprises a set of at least three adjacent layers characterized by:
(a) a linear fit to the set's POAs has an R-squared value of at least 0.85.

The filter is further characterized wherein the magnitude of the slope of the linear fit is at least 5 percent per layer.

The filter is further characterized wherein the inner surface of the rolled-up filter has an average diameter ID, the outer surface has an average diameter OD, and the filter has an average wall thickness t given by:

$$t = 1 / 2 ( OD - ID ) ,$$

$$where :$$

$$t / OD \leq 0.07 .$$

In certain embodiments, the filters disclosed herein can be up to 48% lighter than traditional airbag filters, while cooling and cleaning more efficiently and achieving more tank performance output. For example, cooling efficiency can be increased by as much as 40% per gram of filter weight compared to traditional expanded metal filters, which means that more moles of gas can be generated at the same or lower exit gas temperatures. By means of the filters disclosed herein, manufacturers of airbag inflators can build smaller envelope inflators for less cost, not only because of filter weight savings, but also because the entire inflator can be made smaller, including the inflator's steel housing. In some cases, the amount of solid propellant needed to generate the airbag inflating gases can be reduced. Compared to traditional filters, the wall thickness of the filter can be 50% or more smaller than traditional airbag filters while achieving the same or better cooling efficiency than traditional filters.

A variety of modifications that do not depart from the scope and spirit of the invention will be evident to persons of ordinary skill in the art from the foregoing disclosure. For example, while the filters have been described in the context of airbag inflators, they can also be used in a variety of other applications. The following claims are intended to cover the specific embodiments set forth herein as well as modifications, variations, and equivalents of those embodiments.

What is claimed is:

1. A filter comprising a strip of expanded metal rolled-up about an axis to form multiple layers, said strip of expanded metal having a longitudinal axis and a transverse axis and comprising a plurality of apertures arranged in rows oriented perpendicular to the longitudinal axis, the strip being rolled up along the longitudinal axis to form the filter, wherein:
(I) the rolled-up filter has an inner surface and an outer surface;
(II) each of the filter's layers comprises a plurality of apertures having an average open area OA;
(III) the strip of expanded metal comprises an entrance zone which forms a plurality of layers in the rolled-up filter and a nozzle zone which forms a single layer in the rolled-up filter, the entrance zone being adjacent to the nozzle zone with the entrance zone being closer to the inner surface of the rolled-up filter than the nozzle zone;
(IV) the OA of the single layer of the nozzle zone is smaller than the OAs of all of the layers of the entrance zone; and
(V) the plurality of layers of the entrance zone comprises a set of at least three adjacent layers characterized by:
(a) the set's OAs monotonically decrease from the layer closest to the inner surface to the layer closest to the outer surface; and
(b) a linear fit to the set's OAs has a R-squared value of at least 0.80.

2. The filter of claim 1 wherein the magnitude of the slope of the linear fit is at least 0.04 square millimeters per layer.

3. The filter of claim 1 wherein the inner surface of the rolled-up filter has an average diameter ID, the outer surface has an average diameter OD, and the filter has an average wall thickness t given by:
$$t = 1 / 2 ( OD - ID ) ,$$
$$where :$$
$$t / OD \leq 0.07 .$$

4. A filter comprising a strip of expanded metal rolled-up about an axis to form multiple layers, said strip of expanded metal having a longitudinal axis and a transverse axis and comprising a plurality of apertures arranged in rows oriented perpendicular to the longitudinal axis, the strip being rolled up along the longitudinal axis to form the filter, wherein:
(I) the rolled-up filter has an inner surface and an outer surface;
(II) each of the filter's layers comprises a plurality of apertures having an average longitudinal dimension LD;
(III) the strip of expanded metal comprises an entrance zone which forms a plurality of layers in the rolled-up filter and a nozzle zone which forms a single layer in the rolled-up filter, the entrance zone being adjacent to the nozzle zone with the entrance zone being closer to the inner surface of the rolled-up filter than the nozzle zone;
(IV) the LD of the single layer of the nozzle zone is smaller than the LDs of all of the layers of the entrance zone; and
(V) the plurality of layers of the entrance zone comprises a set of at least three adjacent layers characterized by:
(a) the set's LDs monotonically decrease from the layer closest to the inner surface to the layer closest to the outer surface; and
(b) a linear fit to the set's LDs has a R-squared value of at least 0.8.

5. The filter of claim 4 wherein the magnitude of the slope of the linear fit is at least 0.04 millimeters per layer.

6. The filter of claim 4 wherein the inner surface of the rolled-up filter has an average diameter ID, the outer surface has an average diameter OD, and the filter has an average wall thickness t given by:
$$t = 1 / 2 ( OD - ID ) ,$$
$$where :$$
$$t / OD \leq 0.07 .$$

7. A filter comprising a strip of expanded metal rolled-up about an axis to form multiple layers, said strip of expanded metal having a longitudinal axis and a transverse axis and comprising a plurality of apertures arranged in rows oriented perpendicular to the longitudinal axis, the strip being rolled up along the longitudinal axis to form the filter, wherein:
(I) the rolled-up filter has an inner surface and an outer surface;
(II) each of the filter's layers comprises a plurality of apertures having an average transverse to longitudinal aspect ratio AR;
(III) the strip of expanded metal comprises an entrance zone which forms a plurality of layers in the rolled-up filter and a nozzle zone which forms a single layer in the rolled-up filter, the entrance zone being adjacent to the nozzle zone with the entrance zone being closer to the inner surface of the rolled-up filter than the nozzle zone;
(IV) the AR of the single layer of the nozzle zone is larger than the ARs of all of the layers of the entrance zone; and
(V) the plurality of layers of the entrance zone comprises a set of at least three adjacent layers characterized by:
(a) the set's ARs monotonically increase from the layer closest to the inner surface to the layer closest to the outer surface; and
(b) a linear fit to the set's ARs has a R-squared value of at least 0.8.

8. The filter of claim 7 wherein the magnitude of the slope of the linear fit is at least 0.04 per layer.

9. The filter of claim 7 wherein the inner surface of the rolled-up filter has an average diameter ID, the outer surface has an average diameter OD, and the filter has an average wall thickness t given by:
$$t = 1 / 2 ( OD - ID ) ,$$
$$where :$$
$$t / OD \leq 0.07 .$$

10. A filter comprising a strip of expanded metal rolled-up about an axis to form multiple layers, said strip of expanded metal having a longitudinal axis and a transverse axis and comprising a plurality of apertures arranged in rows oriented perpendicular to the longitudinal axis, the strip being rolled up along the longitudinal axis to form the filter, wherein:
(I) the rolled-up filter has an inner surface and an outer surface;
(II) each of the filter's layers has an average percent open area POA;
(III) the strip of expanded metal comprises an entrance zone which forms at least three layers in the rolled-up filter and a nozzle zone which forms a single layer in the rolled-up filter, the entrance zone being adjacent to the nozzle zone with the entrance zone being closer to the inner surface of the rolled-up filter than the nozzle zone;
(IV) the POA of the single layer of the nozzle zone is smaller than the POAs of all of the layers of the entrance zone; and
(V) the plurality of layers of the entrance zone comprises a set of at least three adjacent layers characterized by:
(a) a linear fit to the set's POAs has an R-squared value of at least 0.85.

11. The filter of claim 10 wherein the magnitude of the slope of the linear fit is at least 5 percent per layer.

12. The filter of claim 10 wherein the inner surface of the rolled-up filter has an average diameter ID, the outer surface has an average diameter OD, and the filter has an average wall thickness t given by:
$$t = 1 / 2 ( OD - ID ) ,$$
$$where :$$
$$t / OD \leq 0.07 .$$
